(19) United States
(12) Patent Application Publication
(10) Pub. No.: US 2016/0332502 A1
(43) Pub. Date: Nov. 17, 2016

(54) HVAC CONTROL FOR VEHICLES WITH START/STOP ENGINES

(71) Applicant: Ford Global Technologies, LLC, Dearborn, MI (US)

(72) Inventors: James ROLLINSON, Superior Township, MI (US); Paul Bryan HOKE, Plymouth, MI (US); Michael Steven WALLIS, Belleville, MI (US)

(21) Appl. No.: 15/223,766

(22) Filed: Jul. 29, 2016

Related U.S. Application Data
(63) Continuation-in-part of application No. 13/894,486, filed on May 15, 2013.

(51) Int. Cl. B60H 1/00

(52) U.S. Cl. CPC B60H 1/00742; B60H 1/00778; B60H 1/00878; B60H 1/00985; B60H 1/004; B60H 1/00064; B60H 1/00971; B60H 2001/002

(57) ABSTRACT

A vehicle HVAC system is described that comprises a front control interface, a rear control interface, and a climate controller. The front control interface may be manipulated by the driver in the front seat. Manipulating the front control interface controls the climate setting for both the front and rear areas of the vehicle. The rear control interface, located in the rear area of the vehicle, is accessible to be manipulated by a passenger seated in the rear area. The controller may be commanded to disable the front control interface and enable the rear control interface to control the climate setting for the rear area.

### CROSS-REFERENCE TO RELATED APPLICATION

This application is a continuation-in-part of U.S. application Ser. No. 13/894,486 filed May 15, 2013, the disclosure of which is hereby incorporated in its entirety by reference herein.

### TECHNICAL FIELD

The present invention relates to a system for controlling a heating ventilation and air conditioning (“HVAC”) system in vehicles with start/stop engines.

### BACKGROUND

To increase fuel economy, vehicle engines may be equipped with an engine start/stop system. The engine start/stop system shuts off the engine when the vehicle is idle. Currently, only front seat occupants are able to override the engine start/stop system based on desired climate settings. However, an occupant in the rear passenger area of a chauffeured vehicle may be the owner of the vehicle and the person whose comfort is of paramount importance. The vehicle owner is not able to control the climate settings of the chauffeured vehicle when the engine stops because of the normal front seat control bias.

One way of improving occupant comfort in a vehicle is to use a climate control system that has a control unit for adjusting the direction of airflow. An air control vent may be adjusted to redirect the direction of the airflow. These systems do not control the start/stop system of the vehicle HVAC system of the vehicle that limits the operation of the vehicle HVAC system and can fail to keep a chauffeured person in the rear seat comfortable when the engine is stopped to save fuel.

Another system for increasing occupant comfort in a vehicle is to determine the blowout condition of the conditioned air. This is done by using an electronic control unit on both the front and rear air conditioning units. Such systems do not allow independent control of the front air conditioning unit and the rear air conditioning unit. The control unit does not allow the occupant in the rear of a vehicle to control an engine start/stop system based upon the comfort level of the rear seat occupants.

Another way of controlling temperature in an automotive vehicle is to have an interface that allows a user to select a driver side temperature setting and a passenger side temperature setting. A seat occupancy sensor may detect whether the passenger seat is occupied and send a signal to a vehicle climate control system controller. When the passenger side area is unoccupied, the climate control system distributes conditioned air according to the driver side temperature setting to both the driver side and the passenger side areas. This type of system only controls the distribution of conditioned air to the front of the vehicle. Such systems do not include an auxiliary HVAC control for rear seat occupants and do not control the engine start/stop system.

This disclosure is directed to the above problems and other problems as summarized below.

### SUMMARY

According to one aspect of this disclosure, a vehicle HVAC system is described that comprises a front control interface, a rear control interface, and a climate controller. The front control interface may be manipulated by the driver in the front seat. Manipulating the front control interface controls the climate setting for both the front and rear areas of the vehicle. The rear control interface, located in the rear area of the vehicle, is accessible to be manipulated by a passenger seated in the rear area. The controller may be commanded to disable the front control interface and enable the rear control interface to control the climate setting for the rear area.

The controller may be actuated by the rear control interface when the vehicle is determined to be a chauffeured vehicle. A selector switch, located in the front area of the vehicle, may be manually actuated to transfer control to the rear area. Alternatively, the controller may be actuated upon detection of a passenger seated in the rear area of the vehicle. A seat occupancy sensor, located in the rear area of the vehicle, may be provided to detect that a rear seat is occupied. There are several ways of detecting that a rear is occupied including a sensor located in the seat, a sensor in the seat belt receiver, a motion detector, a passenger detecting camera, or the like.

The vehicle HVAC system may be for a vehicle that is equipped with an engine capable of being enabled and disabled to reduce fuel consumption. When the engine is disabled, the controller may need to restart the engine to control the climate within the vehicle. The controller may restart the engine when selected climate settings in either the front or the rear areas of the vehicle differ from the current climate in the selected area.

According to another aspect of this disclosure, a HVAC system for a vehicle is described that comprises a front climate interface, a rear climate interface, an occupant sensor, a selector switch, and a controller. The controller may allow the rear climate interface to control the climate settings of a front area and a rear area. When the occupant sensor determines the presence of a rear passenger and the selector switch is actuated, the controller may be programmed to allow the rear control interface to have sole control over climate determinations in the vehicle. The controller prevents a vehicle engine from shutting off when a selected climate setting is outside a climate setting range determined from either the front climate interface or the rear climate interface.

The controller may be actuated by a selector switch located in a front area that may be actuated by a driver in the front area, or by monitoring a sensor or other input indicating that the vehicle is chauffeured. For example, when the vehicle is being chauffeured, the position of the front passenger seat may be shifted forward to provide additional space for the chauffeured person and a seat position sensor may indicate the vehicle is being chauffeured. When a passenger in the rear area is detected, the controller is to be controlled by the rear control interface.

When the selector switch, the seat position switch, or the seat occupancy sensor is actuated, the controller may be programmed to determine that the vehicle is being chauffeured. Once the controller determines that the vehicle is being chauffeured, the controller biases the climate control to the rear climate interface in the rear area of the vehicle. Biasing the climate control to the rear climate interface causes the climate control system to seek to achieve a selected climate of the rear area. Climate sensors monitoring blower voltage, duct temperature, coolant temperature, and relative cabin humidity may be used to determine the climate settings to control the climate of the rear area.

According to a further aspect of this disclosure, a control system is described that comprises a control circuit, a HVAC system, an input, and a climate sensor. The control circuit is configured to enable and disable an engine to reduce fuel consumption. When the engine is disabled, the HVAC system may be disabled. Likewise, when the engine is enabled, the HVAC system is selectively enabled. An input indicative of a rear seat being occupied is communicated to the control circuit to indicate the presence of a chauffeured passenger. When the control circuit receives the input, the rear area climate sensor controls the HVAC system.

The input may be provided in a variety of ways. For example, the input may be a sensor operatively connected to the rear seat. The sensor may be a seat belt sensor in the rear seat, a seat pressure sensor in the rear seat, or a motion detecting sensor activated upon movement in the rear seat. Further, the sensor may be a seat position sensor that provides the input. The seat position sensor may be actuated when a front seat is shifted into a position providing added leg room for the rear seat. The engine may be a combustion engine that provides all traction power for the vehicle. Alternatively, the engine may be an internal combustion engine of a hybrid vehicle that includes an electric traction motor and a battery.

The above aspects of the disclosure and other aspects will be better understood in view of the attached drawings and the following detailed description of the illustrated embodiments.

### BRIEF DESCRIPTION OF THE DRAWINGS

FIG. 1 is a top plan view of a chauffeured vehicle.

FIG. 2 is a diagrammatic view the climate control system.

FIG. 3 is a control logic flow diagram of the climate control system.

### DETAILED DESCRIPTION

The illustrated embodiments are disclosed with reference to the drawings. It should be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but merely as a representative basis for teaching one skilled in the art how to practice the disclosed concepts.

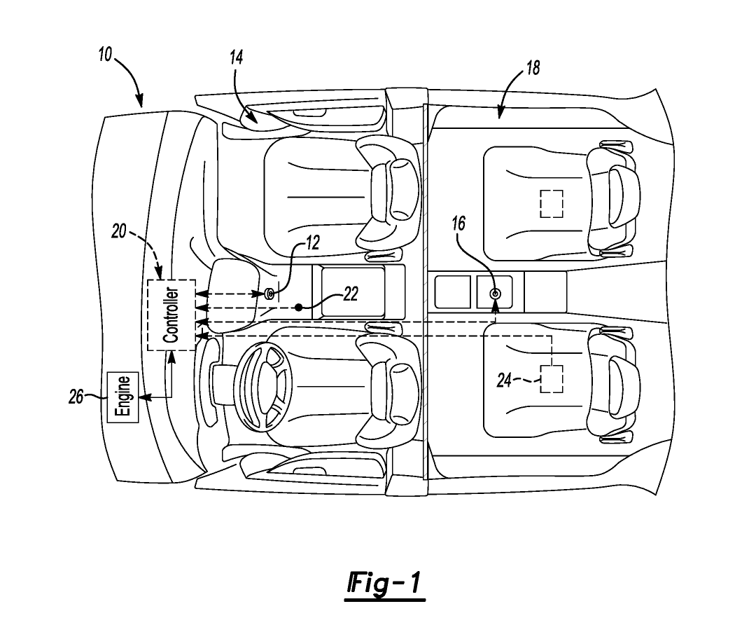

Referring to FIG. 1, a vehicle 10 is shown that includes a front climate interface 12 within the front area 14 and a rear climate interface 16 within the rear area 18. A driver (not shown) in the front area 14 may manipulate the front climate interface 12 to select a climate setting in the front and rear areas 14, 18. The rear climate interface 16 may be manipulated by a rear seat passenger (not shown) to select a climate setting in the rear area 18. A controller 20 may disable the front climate interface 12 to allow the rear climate interface 16 to select the climate settings of the rear area 18. The controller 20 may also allow the rear climate interface 16 to control the climate settings in the front area 14.

A selector switch 22 may be actuated to indicate to the controller 20 that the vehicle 10 is being driven by a chauffeur. The selector switch 22 may be located in the front area 14 and may be actuated manually by the driver in the front area 14. A change in the position of the front passenger seat may also be used to indicate to the controller that the driver is a chauffeur. When the front passenger seat is pushed fully forward, the controller 20 may be switched to allow the rear climate interface 16 to determine the climate settings for the front area 14 and the rear area 18.

The controller 20 may also transfer control to the rear climate interface 16 upon sensing the presence of a passenger (not shown) in the rear area 18. A seat occupancy sensor 24 in the rear area 18 may be actuated by the presence of a rear area 18 passenger. The climate settings for the front area 14 and the rear area 18 may be set by the rear climate interface 16 when the controller 20 determines the presence of a chauffeured passenger.

The vehicle 10 also comprises an engine 26 that selectively generates engine power. The controller 20 controls the climate settings in the front 14 and rear 18 areas. The controller 20 may command restarting the engine 26 when the engine 26 is turned off and the climate settings of the selected front area 14 or rear area 18 require engine operation to provide heat or air conditioning. The rear climate interface 16 may be used to control the climate in the rear area 18 if the controller 20 determines the presence of a chauffeured passenger.

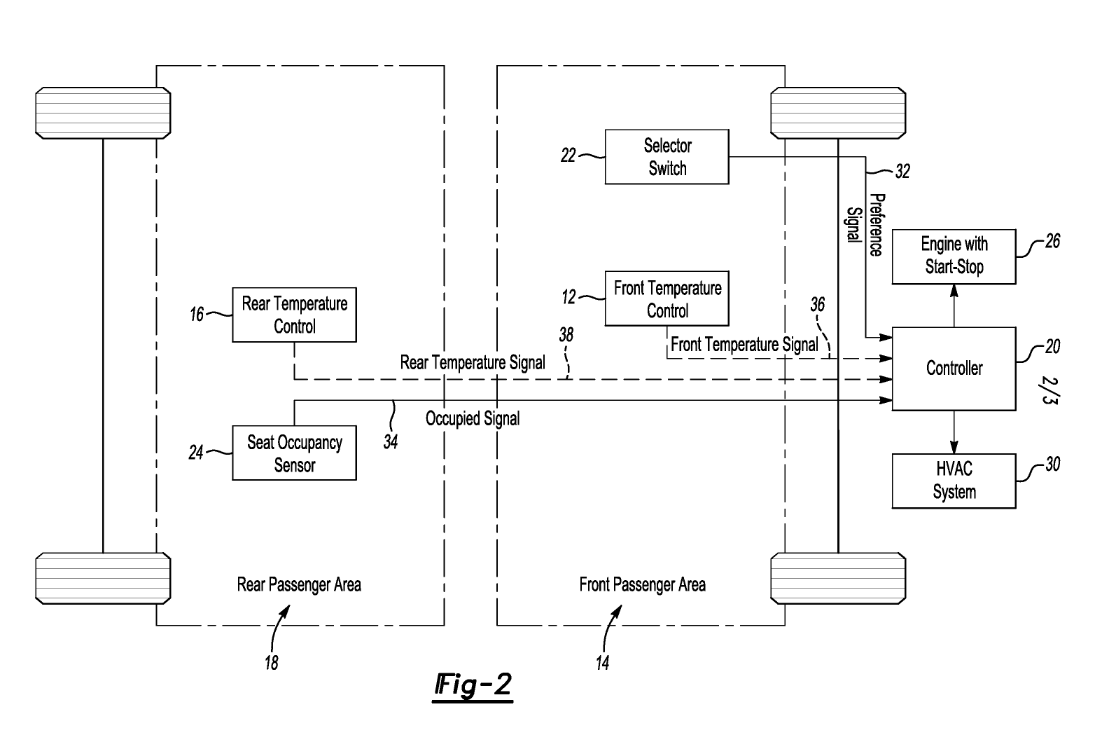

FIG. 2 is a diagrammatic view illustrating operation of a climate control system 30. As will be described in more detail below, the climate control system 30 may include and communicate with the controller 20, the front and rear climate interfaces 12, 16, the selector switch 22, the seat occupancy sensor 24 as well as the engine 26. The system 30 comprises the front climate interface 12 for controlling climate settings in the front area 14 and the rear area 18. The rear climate interface 16 controls the climate setting in at least the rear area 18. The controller 20, when actuated, dictates whether the front control interface 12 or the rear control interface 16 controls the climate setting in the rear area 18.

The controller 20 may be actuated by the selector switch 22 that causes the rear climate interface 16 to govern the climate settings in the rear area 18. When disengaged, the selector switch 22 does not actuate the controller 20 and the front climate interface 12 controls the climate setting for the front 14 and rear 18 areas. The controller 20 may also be actuated by the seat occupancy sensor 24. The seat occupancy sensor 24 detects the presence of a rear passenger (not shown) and when engaged in combination with the selector switch 22 actuates the controller 20. Once the controller 20 is actuated, the rear climate interface 16 controls the climate settings of the rear area 18.

The climate control system 30 may also cooperate with the engine 26. The engine 26 is capable of being enabled and disabled to reduce fuel consumption. When the engine 26 is disabled, the climate control system 30 may also be disabled. When the selected climate is different from the climate setting in the selected front area 14 or rear area 18 and the engine 26 is disabled, the controller 20 may be operative to restart the engine 26. Restarting the engine 26 allows the climate control system 30 to account for the change in climate in the front 14 and rear 18 areas based on the selected climate of the front 12 or rear 16 climate interfaces.

For example, as depicted in FIG. 2, the selector switch 22 may send a preference signal 32 to the controller 20. Likewise, the seat occupancy sensor 24 may send an occupied signal 34 to the controller. If the controller 20 receives both the preference signal 32 and the occupied signal 34, the controller 20 may disable the front climate interface 12 allowing only the rear climate interface 16 to control the climate settings of the rear area 18. In a similar manner, the front climate interface 12 sends a front temperature signal 36 to the controller 20 and the rear climate interface 16 sends a rear temperature signal 38 to the controller 20. In the presence of the preference signal 32 and the occupied signal 34, the front temperature signal 36 may be different from the rear temperature signal 38. Having different front and rear temperature signals 36, 38 allows the climate control system 30 to provide independent temperature climate settings within both the front and rear areas 14, 18. The climate settings in both the front and rear areas 14, 18 may be independently controlled using auxiliary heating ventilation, air conditioning, main heating ventilation, and air-conditioning climate control systems 30.

The front temperature signal 36 and the rear temperature signal 38 may also influence operation of the engine 26. The engine 26 may be a start/stop engine, in which fuel consumption by the engine 26 is reduced by disabling the engine 26 during certain circumstances. Therefore, the controller 20 may be configured to enable, or restart the engine 26 if the rear temperature signal 38 indicates a requirement for heating or cooling. In a similar manner, the controller 20 may be configured to enable, or restart the engine 26 if the front temperature signal 36 indicates a requirement for heating or cooling, being different from the rear temperature signal 38. In at least one other embodiment, the controller 20 may be configured to only restart the engine 26 based on the rear temperature signal 38. For example, in response to receiving the preference signal 32 or the occupied signal 34, the controller 20 may enable or restart the engine 26 if the rear climate interface 16 is adjusted to send a rear temperature signal 38, which requires heating or cooling of the rear area 18. The controller 20 may compare the rear temperature signal 38 with a baseline temperature derived from a temperature sensor (not shown).

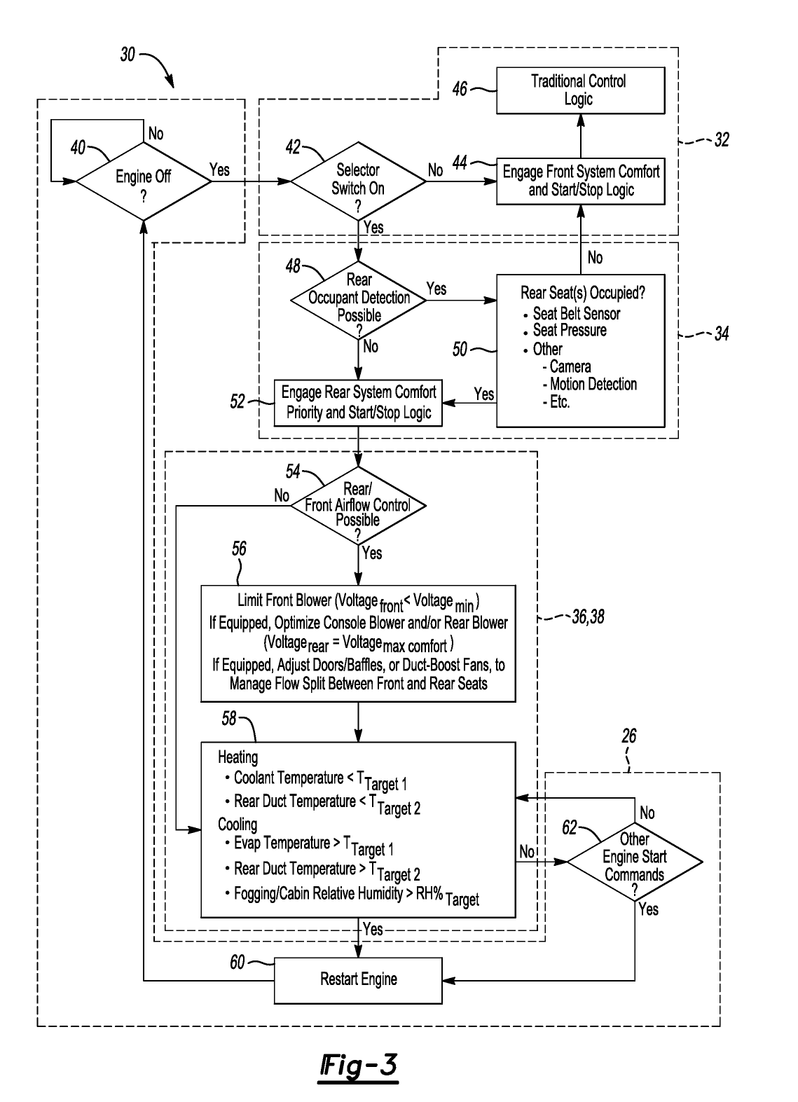

FIG. 3 depicts a control logic flow diagram for the climate control system 30 with specific reference to steps operable via the preference signal 32, the occupied signal 34, the front and rear temperature signals 36, 38 as well as restart commands for the engine 26. The climate control system 30 starts by determining whether the engine 26 is off at 40. The climate control system 30 continuously monitors the state of the engine 26 at 40. For example, if at 40, the engine 26 is on, the climate control system 30 may be configured to continuously monitor the state of the engine 26 until the engine 26 is off at 40. The climate control system determines that the engine is off at 40, the climate control system 30 checks the status of the preference signal 32 to determine if the selector switch has been actuated at 42.

If at 42, the climate control system 30 determines that the preference signal 32 indicates that the selector switch has not been activated, the climate control system 30 utilizes front system comfort and traditional start/stop logic for the engine at 44. For example, if the selector switch has not been activated at 42, the front climate interface 12 may be used to set the climate settings of the front area 14 at 44. Likewise, if the selector switch has not been activated at 42, conventional start/stop logic may be used to determine the appropriate circumstances to restart the engine and conserve fuel at 44. Using the front climate interface 12 to set the climate settings of the front area 14 at 44 results in traditional control logic used by the climate control system 30 at 46 to adjust the climate settings in either or both the front and rear areas 14, 18. Therefore, the control logic driving the climate control system 30 may end at 46 by using the traditional control logic.

If at 42, the climate control system 30 determines that the preference signal 32 indicates that the selector switch has been activated, the climate control system 30 checks the status of the occupied signal 34 at 48. At 48, the climate control system 30 determines via the occupied signal 34 if rear occupant detection is possible. If rear occupant detection is possible at 48, the occupied signal 34 may indicate whether the rear area 18 is occupied at 50. Determining whether the rear area 18 is occupied at 50 may include, but is not limited to, detecting a seatbelt sensor, detecting seat pressure, interpreting an image from the camera, using motion detection or any other method of determining whether the rear area 18 is occupied at 50. If at 50, the occupied signal 34 indicates that the rear area 18 is not occupied, the climate control system 30 engages the front system comfort logic at 44 described above. If at 50, the occupied signal 34 indicates that the rear area 18 is occupied, the climate control system 30 engages rear system comfort as a priority in determining start/stop logic of the engine at 52. Again, the rear system comfort as priority at 52 is consistent with disabling the front climate interface 12 in using the rear climate interface 16 to set the climate settings of the rear area 18 in order to prioritize the climate settings to an owner riding in the rear area 18 of a chauffeured vehicle. Further, the rear system comfort as priority at 52 may also determine the on or off state of the engine as will be described in more detail below.

If the climate control system 30 uses the rear system comfort as priority at 52, the climate control system 30 then uses the front and rear temperature signals 36, 38 to determine if front and rear air flow control is possible at 54. If at 54, the front and rear temperature signals 36, 38 indicate to the climate control system 30 that front and rear air flow control is possible, the climate control system 30 may control the airflow by limiting blower voltage at 56. For example, the climate control system 30 may maintain the front blower voltage being less than a minimum blower voltage at 56. Likewise, the climate control system 30 may control the airflow by optimizing console blower voltage and rear blower voltage, either independently or simultaneously, if equipped on the vehicle. For example, the climate control system 30 may maintain the rear blower voltage as being equal to a voltage for maximum comfort at 56. The climate control system 30 may also control airflow at 56 by adjusting vent doors or baffles, or duct-boost fans to manage airflow's split between the front and rear areas. Again, the front and rear temperature signals 36, 38 allow the climate control system 30 to manipulate airflow at 56 to further optimize the climate settings in the front and rear areas.

The front and rear temperature signals 36, 38 may further indicate to the climate control system 30 whether heating or cooling is required in the front and rear areas, respectively at 58. For example, if coolant temperature is less than a target, or threshold temperature, or a rear duct temperature is less than a target, or threshold temperature at 58, then the climate control system 30 via the front and rear temperature signals 36, 38 may provide heating to either of the front or rear areas. Likewise, if an evaporator temperature is greater than a target, or threshold temperature, or a rear duct temperature is greater than a target, or threshold temperature at 58, then the climate control system 30 via the front and rear temperature signals 36, 38 may provide cooling to either of the front or rear areas. At 58, the relative humidity within the front and rear areas, or fogging being greater than a relative humidity percentage target, or threshold may also indicate to the climate control system 30 via the front and rear temperature signals 36, 38 to provide cooling to the front and rear areas. If front and rear airflow control is not possible at 54, the climate control system 30 may determine heating or cooling requirements at 58 just discussed.

If the climate control system 30 determines a heating or cooling requirement via the front and rear temperature signals 36, 38 at 58, the climate control system 30 may then revert to determining operational states of the engine 26. For example, if the climate control system 30 determines heating or cooling requirements at 58, then the climate control system 30 may then indicate to the controller 20 to enable, or restart the engine 26 at 60. However, the climate control system 30 determines that heating or cooling is not required, the climate control system 30 may then indicate to the controller 20 to check for other engine start commands at 62. If at 62, no other engine start commands are present, the climate control system 30 may be in continuous communication with the controller 22 communicate heating or cooling requirements at 58, which may result in an engine start command at 62. If at 62, the controller 20 determines the presence of an engine start command, the controller 20 may then restart, or enable the engine 26 at 60. When the engine 26 has been restarted, or enabled at 60, the climate control system 30 may then revert to determining whether the engine is off at 40, as described above. While described sequentially, the logic of the climate control system 30 described above may be accomplished in any ordering of the steps, which allows for rear priority in setting the climate settings of at least the rear area based on actuation of a selector switch.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A heating ventilation and air conditioning system for a vehicle comprising:
a front climate interface to set a climate setting of a front area and a rear area;
a rear climate interface to set a climate setting of the rear area;
an occupant sensor to detect an occupied rear seat;
a selector switch actuatable by a vehicle occupant; and
a controller to allow the rear climate interface to control the climate setting of the rear area under conditions of a detected rear occupant or an actuated selector switch, and to prevent a vehicle engine from shutting off when the climate settings are different.

2. The heating ventilation and air conditioning system of claim 1 wherein:
the rear climate interface is further configured to be manipulated by a passenger seated in the rear area.

3. The heating ventilation and air conditioning system of claim 1 wherein:
the controller is further configured to change the climate of a selected one of the front or rear areas based upon a selected climate setting range.

4. The heating ventilation and air conditioning system of claim 1 further comprising:
at least one climate sensor configured to detect a current climate setting in each of the front and rear areas.

5. A vehicle HVAC system comprising:
a front climate interface that controls front and rear climate settings;
a rear climate interface that controls the rear climate setting; and
a controller configured to, in response to actuation of a switch, disable the front climate interface from controlling the rear climate setting, allow the rear climate interface to control the rear climate setting, and restart an engine to achieve the rear climate setting.

6. The vehicle HVAC system of claim 5 wherein:
the rear climate interface is configured to control the front area climate setting.

7. The HVAC system of claim 6 wherein:
the controller being further configured to disable the front climate interface from controlling the front area climate setting such that the rear climate interface controls the front and rear climate settings.

8. The vehicle HVAC system of claim 5 wherein:
the controller disables the front climate interface upon detection of a driver being a chauffeur of the vehicle.

9. The vehicle HVAC system of claim 8 wherein:
the controller is further configured to disable the front climate interface in response to a seat in a front area changing positions to a position different from a preset seat position indicative of an owner.

10. The vehicle HVAC system of claim 5 wherein:
the controller disables the front climate interface upon detection of a passenger being seated in the rear area via a camera.

11. The vehicle HVAC system of claim 10 further comprising:
a seat occupant sensor to detect a passenger seated in a rear area, the controller being in communication with the seat occupant sensor such that the controller disables the front climate interface upon the seat occupant sensor detecting a passenger being seated in the rear area.

12. The vehicle HVAC system of claim 5 wherein:
the controller is disables the front climate interface upon detection of a driver being a chauffeur of the vehicle and upon detection of a passenger seated in a rear area.

13. The vehicle HVAC system of claim 5, wherein:
the controller is further configured to enable the front climate interface to control the rear climate setting in a rear area.

14. The vehicle HVAC system of claim 5 further comprising:
an engine configured to be enabled and disabled, via the controller, to reduce fuel consumption wherein the controller is further configured to restart the engine, after the engine has been disabled, based on the front and rear climate settings being different from a climate of one of a front and rear area.

15. A control system comprising:
a control circuit enables and disables an engine to reduce fuel consumption;
a heating ventilation and air conditioning system may be disabled when the engine is off and is selectively enabled when the engine is operating;
an input indicative of a rear seat being occupied provided to the control circuit; and a climate sensor controls the heating ventilation and air conditioning system based upon a rear seat condition when the input is received by the control circuit.

16. The control system of claim 15 further comprising:
a sensor monitoring the rear seat that provides the input indicative of the rear seat being occupied.

17. The control system of claim 15 further comprising:
a seat position sensor attached to a front seat that provides the input when the front seat is shifted to a position to provide added leg room for the rear seat.

18. The control system of claim 15 wherein:
the engine is an internal combustion engine that is part of a hybrid electric vehicle that also includes an electric traction motor and a battery.

19. The control system of claim 15 wherein:
the engine is a combustion engine that provides all traction power for a vehicle.
